(19) United States
(12) Patent Application Publication
(10) Pub. No.: US 2026/0236926 A1
(43) Pub. Date: Aug. 13, 2026

(54) A Multi-Profile Fraud Detection System For Detecting Suspicious Airline Ticket Sales Activities

(71) Applicants: YILDIZ TEKNIK ÜNIVERSITESI DÖNER SERMAYE ISLETME MÜD, Istanbul (TR); YILDIZ TEKNOLOJI TRANSFER OFISI ANONIM SIRKETI, Istanbul (TR)

(72) Inventors: MEHMED TAHA ARAS; MEHMET AMAÇ GÜVENSAN

(21) Appl. No.: 19/153,950

(22) PCT Filed: Oct. 1, 2024
(86) PCT No.: PCT/TR2024/051123

§ 371 Date: Aug. 5, 2025

(30) Foreign Application Priority Data
Oct. 9, 2023 (TR) 2023/012715

(51) Int. Cl. G06Q 20/40

(52) U.S. Cl. CPC G06Q 20/4016

(57) ABSTRACT

This invention relates to a method that enables the detection of fraud activities in sales transactions carried out via computer networks, in particular the detection of fraud activities in ticket and service sales in the aviation field. The invention allows to overcome the performance limitations caused by imbalanced distributed transactional datasets during a computer-implemented fraud detection. The invention also makes a tangible contribution to the profitability of airline companies by reducing the financial losses experienced by the airline companies due to fraudulent transactions, and the loss of customers that may occur after such transactions.

### TECHNICAL FIELD

This invention relates to a method that enables the detection of fraud activities in sales transactions carried out via computer networks, in particular, the detection of fraud activities in ticket and service sales in the aviation field.

### BACKGROUND OF THE INVENTION

Fraud instances with stolen credit cards are increasing on digital platforms where product sales and money transfers take place. Such increase results in serious income losses and sufferings of the companies that are supposed to ensure security. In order to prevent this, some solutions have been developed. EP1356438B1 describes a method for verification by matching a set of information during sales transactions. However, such methods are insufficient in cases where extensive stolen information is used.

In order to prevent income losses resulting from such fraud cases, some fraud detection systems using machine learning and deep learning techniques have been developed. However, due to the fact that these systems mainly work on transaction-based payment/sales datasets, they may ignore the history of a relevant transaction and transactions linked to it. Since the fraud detection problem has a historical and chronological nature, a limited level of success can be achieved with the transactional datasets.

Another problem experienced in fraud detection applications is dataset imbalance. The number of fraudulent transactions is far less than that of legitimate transactions. This rate appears to be approximately 0.02%. The problem of imbalanced datasets causes a tendency to make negative decisions in terms of all records in the attempts for maximizing the accuracy value. Undersampling methods are often used to solve this problem. This can cause inefficient negative sample selection, such as clustering of the selected samples in any area of the dataset, repetitive selection of the records or selection of independent records, if the selection is completely random, which can mislead classification mechanisms. Oversampling methods, which are used as an alternative to undersampling to solve the imbalanced dataset problem, result in an increase in the number of records, increase computer processing costs, and accordingly, system requirements, and reduce performance efficiency in systems working on large datasets.

In order to overcome the performance limitations caused by transactional datasets, clustering techniques or deep learning techniques such as recurrent neural networks (RNN) and long short term memory (LSTM) that include memory units at the algorithmic level are employed in the prior art. In clustering techniques, the dataset is divided into groups, but these groups are determined on the basis of the similarity of the transactions according to certain parameters, not based on the related histories of the transactions. Nevertheless, such clustering techniques do not guarantee to provide the historical links that are crucial in fraud detection.

The algorithms that include memory units in deep network architecture, such as the LSTM, store the desired information in the memory for representation same in short and long data types and use them in the learning phase. However, such architectures require that the statistics associated with each credit card, the PNR (passenger name record) and other objects in the fraud dataset to be handled independently. In other words, object-based memories should be used instead of global or local memories. In this case, it limits the maximum achievable success of the memory-based deep learning techniques such as the LSTM.

Fraudulent transactions also cause a financial problem for companies. However, in the prior art, the success of fraud detection is determined based on the number of transactions detected and does not reflect the cost associated with fraud activities.

### OBJECTS OF THE INVENTION

An object of the present invention is to provide a method for detecting fraudulent transactions in airline ticket and service sales. In particular, the object is to provide a computer-implemented fraud detection method that uses historical data relations, which allows to overcome the performance limitations caused by imbalanced transactional datasets.

With the invention, it is possible to reduce the financial losses experienced by airline companies due to fraudulent transactions, and customer losses that may occur after such transactions. Thus, a tangible contribution is made to the profitability of airline companies.

### SUMMARY OF THE INVENTION

In the fraud detection method of the invention, machine learning and deep learning techniques are used in combination with a profile-based approach to overcome the constraints of transactional datasets. This can prevent incidents where security measures can be bypassed by trying a number of different credit cards, phone numbers, or e-mail information.

Within the scope of the invention, profiles of not only the users but also of the credit cards and the PNR objects can be generated to prevent the use of risky tools. In addition, suspicious transactions can also be detected by extracting meaningful information from the transactions.

In the fraud detection method of the invention, a hybrid sampling mechanism has been developed that includes a balanced random undersampling (BRUS) algorithm along with some oversampling techniques so as to utilize them without leading to inefficient negative sample selection from an imbalanced dataset. In the hybrid sampling mechanism, first of all, the number of samples is reduced to a certain level with the BRUS algorithm, and then a ratio of the records of fraudulent transactions to legitimate transactions is balanced by oversampling the positive records. The range in which the tendency of the decision mechanism to mark all records as negative is avoided in order to maximize success, is defined as the balanced level range. Generally, this ratio is set between 1:5 and 1:10 fraud/legitimate transaction ratio.

The invention also provides a cost-sensitive measurement mechanism so as to take into account the cost along with the number of transactions during the detection of fraud. According to the invention, while a complexity matrix is being generated, each transaction is weighted based on a respective price value and added to a complexity matrix. Thus, the metrics generated using the complexity matrix can also be obtained in a cost-sensitive manner.

### DETAILED DESCRIPTION OF THE INVENTION

The fraud detection method of the invention mainly comprises the steps of:
receiving a dataset containing a series of sales requests and sales transactions,
receiving those profiles containing past transactions of all objects included in each transaction in the dataset in chronological order,
updating the received profiles by adding a record of the last transaction,
generating a profile-based dataset,
feeding the dataset into a balanced random undersampling algorithm in order to obtain a dataset in which legitimate and fraudulent transactions are distributed in a balanced manner,
preferably, oversampling the undersampled dataset,
feeding the dataset into a deep neural network,
generating two complexity matrices for the outputs of the deep neural network, weighted based on the number of transactions and the cost of transactions,
generating performance metrics from the complexity matrices,
training the deep neural network with feedback of the performance metrics.

Each data object that can establish a relationship between the transactions in the dataset and that is supposed to make a contribution to the decision mechanism due to its structure can be defined as a profile. These profiles generally contain statistical information. During the profiling process, information about previous records is included in the statistical fields in the profiles, on whichever record of the dataset the transaction is being performed at that moment. In addition to the statistical profiles, a local profile (in-record finding profile) was also generated, which reveals some hidden information within the record and belongs only to that record.

The process steps of receiving profiles, updating profiles and generating a profile-based dataset are performed by a multi-profiling mechanism. In the multi-profiling mechanism, fields are created to represent the history of the profiles in each transaction. In order to fill these fields with appropriate values, the entire dataset is scanned chronologically. During the scanning, credit card profiles are stored in the memory and each transaction uses the information that is currently available in the memory. Once all the historical information associated with a profile is processed, scanning is resumed by calculating new statistics and overwriting the previous record so as to update the memory. When the scanning process is completed and all the profiled fields are filled in, a profile-based dataset is obtained, i.e., the dataset is converted into a profile-based format. Examples of some of the profiles that can be created by the multi-profiling mechanism, and the fields associated with these profiles are given below.

A first profile created by the multi-profiling mechanism is a credit card profile. All transactions are profiled according to the respective credit card number. The data fields that can be used in relation with the credit card profile are listed below.
Number of chargebacks in the past
Number of accepted transactions in the past
Number of rejected transactions in the past
Number of transactions submitted for manual review in the past
Number of previous domestic flights purchased with this credit card
Number of previous international flights purchased with this credit card
Number of unique phone numbers used in the past with this credit card
Number of unique email addresses used in the past with this credit card
Average price spent with this credit card in the past
Highest price spent with this credit card in the past

A second profile created by the multi-profiling mechanism is the PNR profile. All transactions are profiled according to the respective PNR code. The data fields that can be used in relation with the PNR profile are listed below.
Number of chargebacks in the past
Number of accepted transactions in the past
Number of rejected transactions in the past
Number of transactions submitted for manual review in the past
Number of previous domestic flights attempted to be purchased in this PNR code
Number of previous international flights attempted to be purchased in this PNR code
Number of unique credit cards used in the past with this PNR code
Number of unique phone numbers used in the past with this PNR code
Number of unique email addresses used in the past with this PNR code

A third profile created by the multi-profiling mechanism is in-record finding profile. This profile contains information about the current transaction, not past transactions. The data fields that can be used in relation with the in-record finding profile are listed below.
The time to flight at the time a request for the current transaction is received, e.g. the number of minutes
Information on whether the surname of the credit card holder matches the surname of any passenger on the relevant flight

An example of the dataset profiling algorithm that can be used by the multi-profiling mechanism is also provided below.

| | |
|---|---|
| 1: | for each record ∈ dataset do |
| 2: | statisticsᵢ ← map[creditCardNumberᵢ] |
| 3: | if statisticsᵢ = null then |
| 4: | initialize(statisticsᵢ) |
| 5: | else |
| 6: | newStatistics ← recalculate(statisticsᵢ) |
| 7: | end if |
| 8: | record[j] ← statisticsᵢ[j] |
| 9: | statisticsᵢ ← newStatistics |
| 10: | end for |

In the invention, the BRUS algorithm is used to prevent the generation of imbalanced dataset and inefficient negative sample selection, which can maximize the representation of the dataset and eliminate disproportions arising from random selection. With the BRUS algorithm, it is guaranteed that the records selected from the majority class will be evenly distributed in the dataset, chronological order is guaranteed in the newly created dataset, and same records are prevented from being selected more than once.

A hybrid sampling algorithm can also be used in the invention by oversampling the undersampled dataset following the undersampling process performed by the BRUS algorithm. With the oversampling performed within the scope of the hybrid sampling algorithm, the fraud/legitimate transaction ratio can be increased to the desired ratio so that the deep neural network is trained.

The process steps of generating a complexity matrix weighted based on the cost of the transactions, and accordingly, the performance metrics are performed by a cost-sensitive measurement mechanism. The performance metrics obtained from the complexity matrix are accuracy, precision, recall, and F1 score. The cost-sensitive measurement mechanism ensures that the fraud detection success is realized by taking into account the transaction costs, unlike the known solutions in the art, in which success is calculated based on the number of transactions, thereby giving results that are independent of the actual income loss. In this way, it is possible to avoid decisions based on faulty assessments, such as blocking legitimate transactions that could generate high income or allowing transactions that could lead to high financial losses. In addition, comparing the cost-based success with the success based on the number of transactions allows the financial characterization of fraudulent and legitimate transactions in the dataset to be evaluated.

In an exemplary embodiment of the invention, the main steps of the cost-sensitive measurement mechanism are also described below.

Sales transactions of airline companies can be carried out in many different currencies. There may also be differences in the fraud risks in terms of different currencies and therefore the currency is also used as a separate data field. On the other hand, in order to evaluate the cost-based success due to exchange rate differences, an exchange rate standardization is performed. In this process, the price information for each transaction is converted into a specific currency in accordance with the values at the time of performance thereof.

In order to reduce the cost of computer processing, preferably after the exchange rate standardization, the price are normalized to between 0-1 using a min-max normalization process.

After the exchange rate standardization and price normalization, a cost-based complexity matrix is generated. To generate the cost-based complexity matrix, TP (true positive), TN (true negative), FP (false positive) and FN (false negative) values are updated by adding the standardized and normalized price weight (cScore) of the processed transaction. The c values of each transaction for which a matrix is generated are calculated as follows:

$$c = currencyUSDRatio * price$$

$$cScore = ( {c}_{i} - min ( c ) ) / ( max ( c ) - min ( c ) )$$

The deep neural networks used in the inventive method are optimized for use in the airline sector. For this purpose, optimization and calibration tests are performed on the network architecture and hyperparameters in order to determine a configuration that provides the highest success on the airline dataset. Then, said deep neural networks are integrated with a multi-profiling mechanism and a cost-sensitive measurement mechanism. Thus, detection of fraud activities can be accomplished by utilizing profiling and deep learning techniques.

In an exemplary embodiment of the invention, the following steps are carried out:
obtaining a 15-months dataset containing fraud information in airline payments in a single file,
deleting or correcting corrupted lines in the file by means of a data corrector, correcting unexpected tokens, standardizing data types, and filling in missing GMT values by matching them with city information,
dividing the data file into monthly data files according to the transaction dates by means of a data divider,
deleting records containing missing or incorrect values in the main fields by means of a data cleaner, standardizing numeric value representations, filling in missing values, deleting dirty and ineffective columns, type checking and correction of numeric values,
combining monthly data files into a single data file by means of a dataset combiner in the same chronological order,
profiling the data file according to profiling rules by means of a profiler,
undersampling the majority records in a balanced manner over the dataset by means of a balanced random undersampler,
excluding reusable data fields by means of a dynamic data processor, excluding data fields with a high number of categories, converting different currencies to a single currency, min-max normalization of numerical fields,
applying one-hot-encoding to categorical data fields in the dataset by means of a one-hot-encoder,
calculating a CHI² value by means of a feature selector,
distributing the transactions by means of a training-test set organizer once they are sorted chronologically by date and time from old to new,
feeding the dataset into a deep neural network,
obtaining results of the transaction number-based measurements and transaction cost-based measurements by means of a success measuring tool.

It is also possible to use any supporting mechanisms such as a visualizer, a file reporter and a logger that is capable of generating test results in tabular form.

We claim:

1. A computer-implemented method for detecting fraud activities in airline ticket and service sales, comprising the steps of:
receiving a dataset comprising a series of airline ticket and service sale requests and sale transactions,
receiving profiles comprising past transactions in chronological order of all objects included in each transaction in the dataset,
updating the received profiles by adding a record of the last transaction,
generating a profile-based dataset,
feeding the dataset into a balanced random undersampling algorithm in order to obtain the dataset in which legitimate and fraudulent transactions are distributed in a balanced manner,
feeding the dataset into a deep neural network,
generating a complexity matrix for the outputs of the deep neural network,
generating performance metrics from the complexity matrices,
training the deep neural network with feedback of the performance metrics.

2. The method according to claim 1, comprising the step of generating the complexity matrix weighted based on the cost of the transactions.

3. The method according to any one of the preceding claims, comprising the step of generating the complexity matrix weighted based on the number of the transactions.

4. The method according to any one of the preceding claims, comprising the step of oversampling the undersampled dataset, which is performed upon the step of feeding the dataset into a balanced random undersampling algorithm to obtain the dataset having a balanced distribution of legitimate and fraudulent transactions.

5. The method according to any one of the preceding claims, wherein a chronological order in the dataset is obtained by means of a balanced random undersampling algorithm.

6. The method according to claim 2, comprising the step of performing an exchange rate standardization before the complexity matrix weighted based on the cost of the transactions is generated.

7. The method according to any one of claim 2 or 4, comprising the step of performing a price normalization before the complexity matrix weighted according to the cost of the transactions is generated.
